(19) United States
(12) Patent Application Publication
(10) Pub. No.: US 2009/0145816 A1
(43) Pub. Date: Jun. 11, 2009

(54) Screen assemblies for shale shakers

(76) Inventors: Paul William Dufilho, Willis, TX (US); David L. Schulte, JR., Willis, TX (US)

Correspondence Address: Guy McClung;PMB 347, 16690 CHAMPION FOREST DR., SPRING, TX, 77379-7023, US

(21) Appl. No.: 12/001,485

(22) Filed: Dec. 11, 2007

(51) Int. Cl. B07B 1/46

(52) U.S. Cl. 209/401; 209/405

(57) ABSTRACT

Screen assemblies for vibratory separators and shale shakers, the screen assemblies in certain aspects having screening material with a protector on an outer periphery of the screening material; and methods of making such screen assemblies. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### BACKGROUND OF THE INVENTION

1. Field of the Invention

The present invention is directed to screen assemblies for shale shakers and vibratory separators and to methods for making them.

2. Description of Related Art

The prior art discloses a wide variety of screens and screen assemblies for use in vibratory separators and shale shakers and methods for making screen assemblies. Many of these screen assemblies employ screening material that as installed in a screen assembly can have exposed rough portions and edges. Known methods for dealing with these rough parts have included grinding the edges in an attempt to smooth them out; cutting or shearing of the screen edges; and applying hot melting tapes or adhesives to the edges. U.S. Pat. No. 6,672,2460 discloses a screen assembly with a lip that forms a rim enclosure with a blunt edge around the perimeter of the screen assembly.

There are a wide variety of patents disclosing screen assemblies for shale shakers and vibratory separators, including, but not limited to, those in U.S. Pat. Nos. 5,967,336; 6,202,856; 4,909,929; 6,543,621; 6,439,392; and in U.S. application Ser. No. 10/473,262 filed Nov. 12, 2002.

There has long been a need, recognized by the present inventor for an effective and efficient assemblies with edges that are easily handled and which are relatively smooth.

### BRIEF SUMMARY OF THE INVENTION

The present invention, in certain aspects, discloses a screen assembly for use in screening material on a vibratory separator in which the material is fed to the screen assembly as the screen assembly is vibrated by vibratory apparatus of the vibratory separator, the screen assembly including: a support for supporting screen mesh, the support having an outer periphery, the screen mesh having an outer edge at the outer periphery of the support, and an edge panel with a portion of the edge panel covering the outer edge of the screen mesh. In certain aspects, the vibratory separator is a shale shaker, and the material to be treated by the screen assembly is drilling fluid with drilled solids from a wellbore operation.

The present invention, in certain aspects, discloses methods for making a screen assembly, the screen assembly for use in screening material to be treated by a vibratory separator, the vibratory separator having vibrating apparatus for vibrating the screen assembly to assist in treating of the material, the method including: placing screen mesh on a support, the screen mesh having an outer edge and the support having an outer periphery; and placing an edge panel on the screen mesh, a portion of the edge panel protecting the outer edge of the screen mesh.

The present invention, in certain aspects, discloses a method for making a screen assembly for a vibratory separator or shale shaker, the method including: placing screen mesh within an opening of a screen support, the screen mesh having an outer edge; maintaining the screen mesh within the opening with a maintenance member; placing an edge panel within the support, the edge panel having an inner part and an outer part, an inner part of the edge panel over the screen mesh's outer edge and the outer part of the edge panel on the screen support; securing the screen mesh to the support; and securing the edge panel to the support.

Accordingly, the present invention includes features and advantages which are believed to enable it to advance vibratory screen technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide the embodiments and aspects listed above and:

New, useful, unique, efficient, nonobvious screen assemblies for vibratory separators and shale shakers with edges of screening material covered with a protective member; and

Methods for making such screen assemblies.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later attempt to disguise it by variations in form or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1A is top view, partially cutaway of a screen assembly according to the present invention.

FIG. 1B is top view of the screen assembly of FIG. 1A with edges removed according to the present invention.

FIG. 1C is a top view of a support frame for the screen assembly of FIG. 1A.

FIG. 1D is a top view showing the screen assembly of FIG. 1A on the support frame of FIG. 1C. according to the present invention.

FIG. 1E is a top view of an edge panel for a screen assembly according to the present invention.

FIG. 1F shows the edge panel of FIG. 1E on the screen assembly of FIG. 1D.

FIG. 2A is an end cross-section view of part of a screen assembly according to the present invention.

FIG. 2B is an end cross-section view of part of a screen assembly according to the present invention.

FIG. 3A is an end view of a screen support for a screen assembly according to the present invention.

FIG. 3B shows the screen support of FIG. 3A with screen mesh thereon according to the present invention.

FIG. 4A is a top view of a screen support according to the present invention.

FIG. 4B is a cross-section view along line 4B-4B of FIG. 4A.

FIG. 4C is a cross-section view along line 4C-4C of FIG. 4A.

FIG. 5A is an end view of screen mesh for use in a screen assembly according to the present invention.

FIG. 5B is an end view showing a screen support for supporting the mesh of FIG. 5A.

FIG. 5C is an end view showing the screen mesh of FIG. 5A adjacent the screen support of FIG. 5B.

FIG. 5D is a top view of a panel for use in a screen assembly according to the present invention.

FIG. 5E shows a screen assembly with the panel of FIG. 5D within the screen support of FIG. 6C.

FIG. 5F shows the screen assembly of FIG. 5E in an upright position.

FIG. 6 is an end cross-section view of part of a screen assembly according to the present invention.

Presently preferred embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

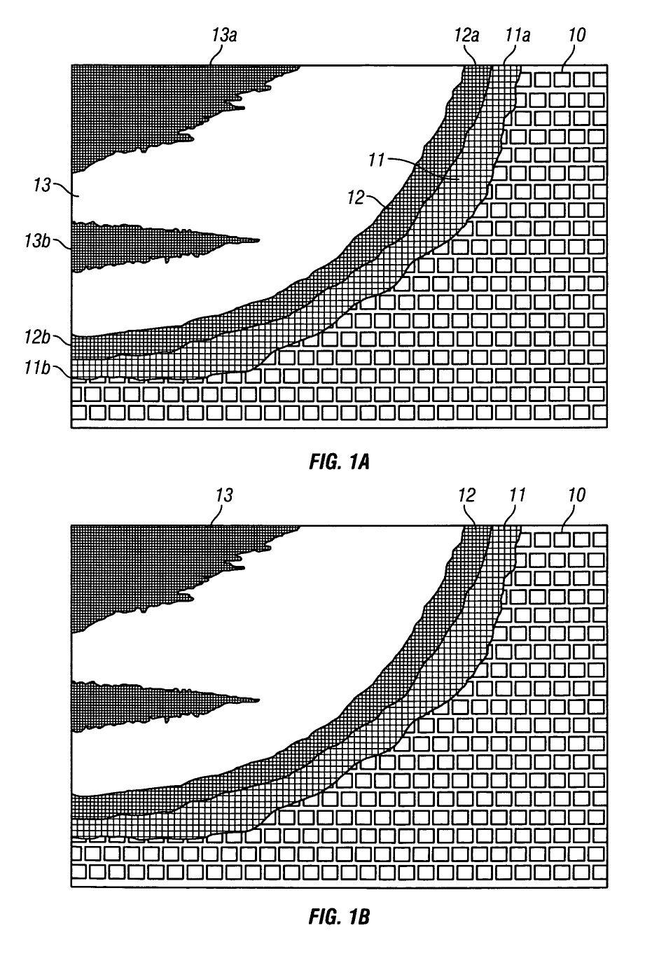

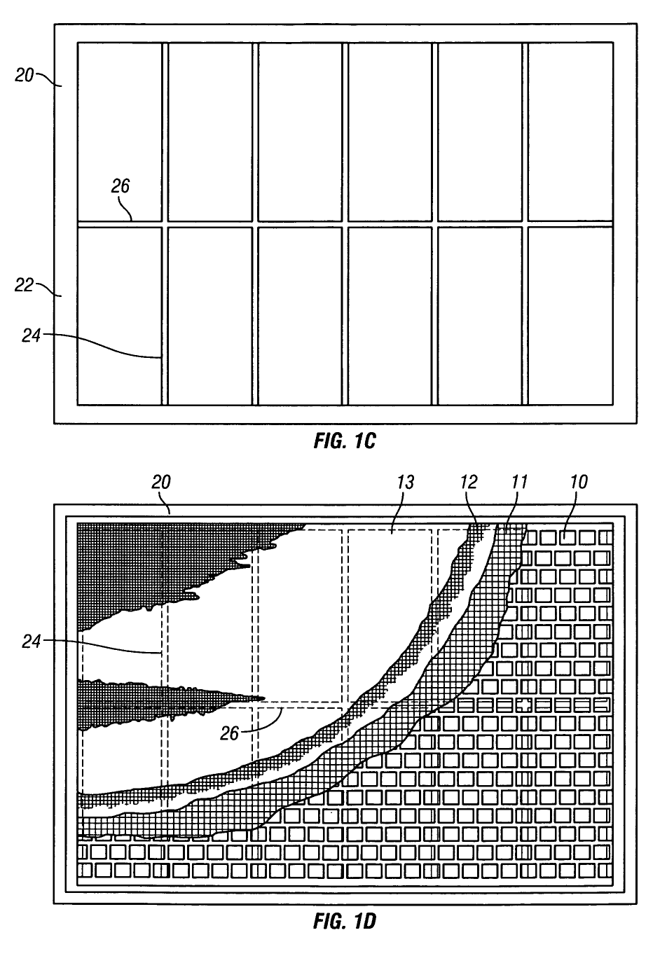

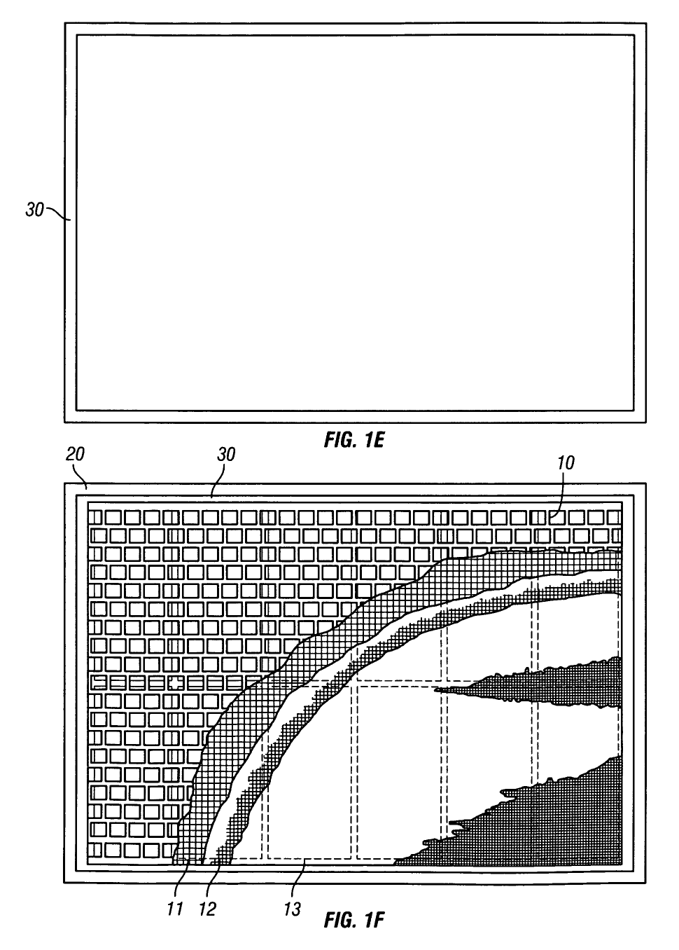

Referring now to FIG. 1A, a perforated plate 10 has thereon a plurality of screen mesh layers 11, 12 and 13, each with some rough edge portions 11a, 11b, 12a, 12b, and 13a, 13b, respectively. Optionally, as shown in FIG. 1B, the rough edges have been removed.

FIG. 1C shows a screen support or frame 20 with an outer frame 22 and crossmembers 24, 26. FIG. 1D shows the combination of the plate 10 with the screen mesh layers 11, 12, 13 secured on the screen support 20. The plate 10 may be secured to the screen support 20 in any known way and the mesh layers 11, 12, 13 may be connected to each other and/or to the plate 10 in any known way. The screen layers 11, 12, 13 may be any known screen mesh or material suitable for use in screen assemblies for a shale shaker or vibratory separator (including, e.g., metal, fiberglass, and plastic).

FIG. 1E shows an edge panel 30 according to the present invention. FIG. 1F shows the edge panel 30 in place over the edges of the screening mesh layers 11, 12, 13. The edge panel 30 may be secured in place by any suitable known method including, but not limited to, securement to the plate 10 with fasteners and/or adhesives with or without fasteners passing through the edges of the layers 11, 12, 13 and/or with or without adhesive contacting the edges of the layers 11, 12 13. Any known suitable screen support or frame may be used in place of the screen support 20 and any suitable known plate or other support may be used in place of the plate 10.

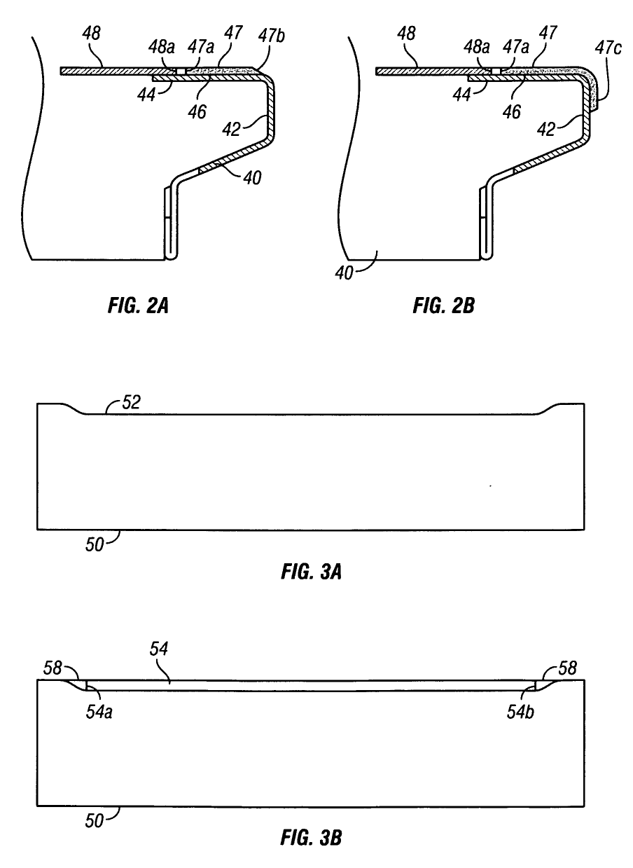

FIG. 2A shows a method according to the present invention for providing a smooth edge for a screen assembly. A screen assembly 40 according to the present invention (shown partially) has a screen support 42 with an upper ledge 44 having an upper surface 46. A combination of layer or layers of screen mesh and a perforated plate 48 (or a layer of layers of screen mesh without a plate) is positioned on the screen support 42. In such a position the combination 48 has an exposed edge 48a. A border panel 47, e.g. like the edge panel of FIG. 1E, is placed on the ledge 44. The border panel 47 has an inner surface 47a which abuts the edge 48a so that the edge 48a cannot be touched. Optionally the panel 47 has a bevelled outer edge 47b.

Optionally, as shown in FIG. 2B, the panel 47 has a downwardly extending lip 47c which lies adjacent a vertical part 42a of the screen support 42. the panel 47 may be made from any suitable material, e.g. metal, stainless steel, fiberglass, plastic, composite, polytetrafluroethylene, polypropylene, polyethylene, or wood.

FIG. 3A is an end or side view of a screen support 50 according to the present invention. The screen support 50 has four sides, each with a recess 52 for receiving a screen layer, a combination of screen layers, or a combination of screen layer(s) and a perforated plate. FIG. 3B shows a screen layer combination 54 positioned within the recesses 52. Edges (all edges; edges 54a, 54b shown) of the screen layer combination 54 are within the recesses 52 and, to this extent, the edges are more difficult to contact than if they were not within the recesses. Optionally spaces within the recesses between the edges and outer wall of the recesses is filled with a filler 58, e.g. plastic, epoxy, or glue.

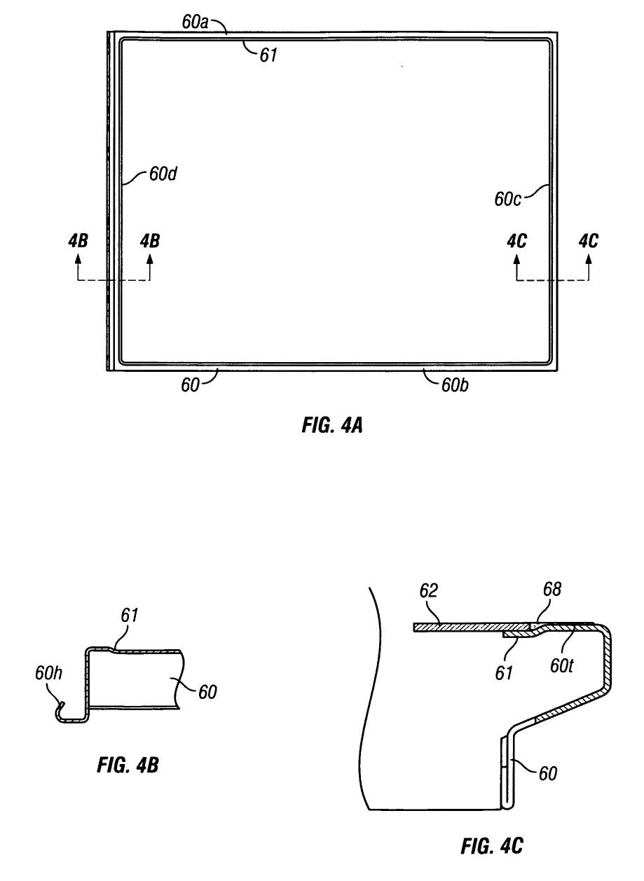

FIGS. 4A-4C show a screen support 60 according to the present invention which has two sides 60a, 60b, an end 60c and an end 60d. All sides and ends include part of a recess 61 which is sized for receiving a screen or screen combination 62 (or combined layers of screen mesh with a perforated plate). Optionally an amount of filler 68 is placed in the space between the edge of the screen combination 62 and the outer edge of the recess 61. Filler can also extend onto a top surface 60t of the screen support 60. Optionally the end 60d may have a hook portion 60h. In one particular aspect the top of the screen combination 62 and the top of the filler material 68 are level with each other.

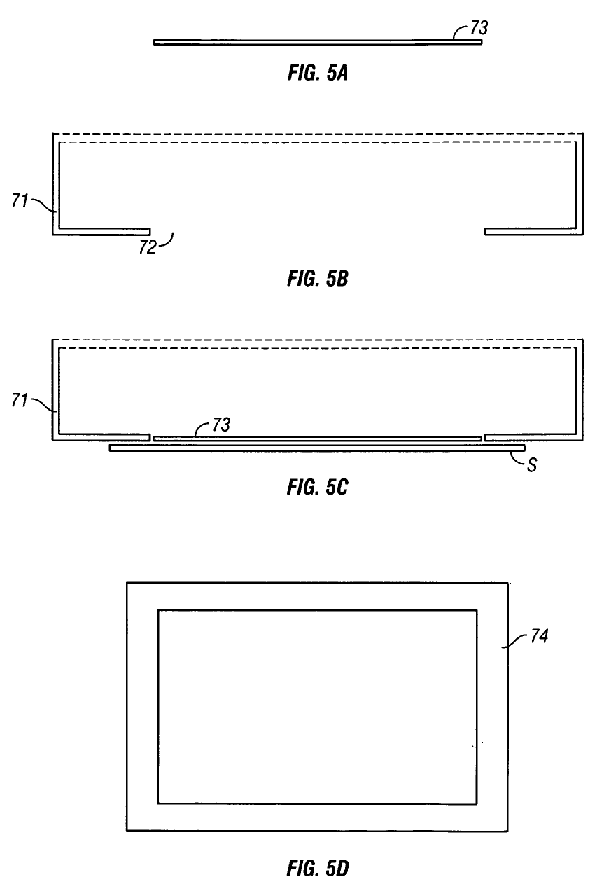

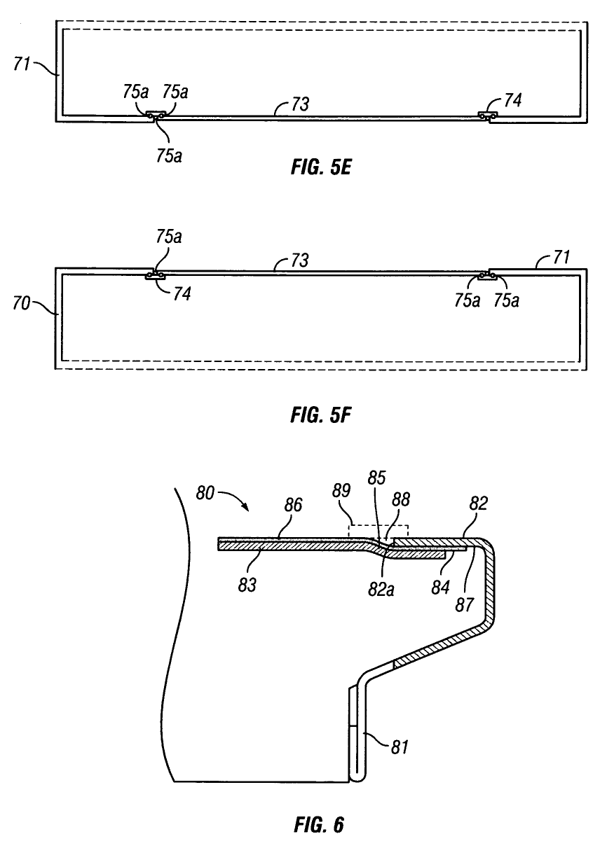

FIGS. 5A-5F illustrate a method for making a screen assembly 70 according to the present invention. A screen support 71 has a top opening 72 into which a screen layer or screen combination 73 (or screen layers plus a perforated plate) is placed, e.g. supported by a maintenance member or support S. An edge panel 74 is placed over (as viewed in FIG. 5E) the edges of the screen combination 73 within the screen support 71. The screen combination 73 may be secured to the screen support 71 in any suitable known manner and the panel 74 may be secured to the screen support 71 and/or to the screen combination in any suitable known manner. For example, amounts of adhesive 75a are used for this securement. In one particular aspect the screen combination 73 is secured to the screen support 71 by a powder coating method and the panel 74 is secured to the screen support by a powder coating method.

FIG. 5F shows the screen assembly 70 with edges of the screen combination 73 within the screen support 71 and not projecting up beyond the top surface of the screen support 71.

FIG. 6 shows (partially) a screen assembly 80 with a support frame 81 with a top member 82 having an underside 87. A perforated plate 83 j (and screening material 84 on the plate 83) may be substantially flat across its surface or, as shown, it may have a bend 85 so that a top surface 86 of the plate 83 (and screening material 84) is level with the top of the top member 82.

The plate 83 and material 84 may be secured to the top member 82 with glue, adhesive, epoxy and/or fasteners. Optionally, filler 88 (shown by dotted line) is put in a space between an outer edge of the plate 83 (and screening material 84) and an inner edge 82a of the top member 82. Optionally, any edge panel 89 (in dotted lines) according to the present invention is used above the inner edge of the top member 82 covering part of the screening material around the periphery of the screening material.

The present invention, therefore, provides in at least some embodiments, a screen assembly for use in screening material on a vibratory separator in which the material is fed to the screen assembly as the screen assembly is vibrated by vibratory apparatus of the vibratory separator, the screen assembly including: a support for supporting screen mesh; the support having an outer periphery; the screen mesh having an outer edge at the outer periphery of the support; and an edge panel secured to the support, a portion of the edge panel covering the outer edge of the screen mesh. Such a screen assembly may have one or some, in any possible combination, of the following: a frame, and the support on and secured to the frame; the support having a peripheral ledge; the screen mesh's outer edge extending around the peripheral ledge of the support, and the edge panel on the peripheral ledge and having an inner surface abutting the screen mesh's outer edge preventing contact with the screen mesh's outer edge; the peripheral ledge having an outer side, and the edge panel having a lip projecting down adjacent the outer side of the peripheral ledge; the peripheral ledge having a top with a first top surface and a second top surface, the first top surface located interiorly of the second top surface, the first top surface lower than the second top surface, the outer edge of the screen mesh extending along the first top surface, a space formed between the outer edge of the first top surface and the second top surface, and filler material filling the space; a portion of the filler material extending onto the second top surface; the screen mesh having a top surface, the filler material having a top surface, and the top surface of the screen mesh level with the top surface of the filler material; the peripheral ledge of the support having a top member, the top member having an underside, and the outer edge of the screen mesh positioned under the underside of the top member of the peripheral ledge; the screen mesh having a bend so that a top surface of the screen mesh is level with a top surface of the top member; the screen mesh is a plurality of layers of screening material stacked together; the support having a plurality os support sides, each support side having a recess, the screen mesh having a plurality of screen sides each screen side including a portion of the outer edge of the screen mesh, and each portion of the outer edge of the screen mesh positioned in a recess of a support side; a space is located between the outer edge of the screen mesh and inner surfaces of the recesses, and filler material fills the space; and/or the vibratory separator is a shale shaker, and the material to be treated by the screen assembly is drilling fluid with drilled solids from a wellbore operation.

The present invention, therefore, provides in at least some embodiments, a screen assembly for use in screening material on a vibratory separator in which the material is fed to the screen assembly as the screen assembly is vibrated by vibratory apparatus of the vibratory separator, the screen assembly including: a support for supporting screen mesh, the support having a peripheral ledge, the support having an outer periphery, the screen mesh having a top surface, an outer edge at the outer periphery of the support, the screen mesh's outer edge extending around the peripheral ledge of the support, an edge panel secured to the support, a portion of the edge panel covering the outer edge of the screen mesh, the edge panel on the peripheral ledge and having an inner surface abutting the screen mesh's outer edge preventing contact with the screen mesh's outer edge, the peripheral ledge has a top with a first top surface and a second top surface, the first top surface located interiorly of the second top surface, the first top surface lower than the second top surface, the outer edge of the screen mesh extending along the first top surface, a space formed between the outer edge of the screen mesh and the second top surface, filler material filling the space, the filler material has a top surface, and the top surface of the screen mesh is level with the top surface of the filler material.

The present invention, therefore, provides in at least some embodiments, a method for making a screen assembly, the screen assembly for use in screening material to be treated by a vibratory separator, the vibratory separator having vibrating apparatus for vibrating the screen assembly to assist in treating of the material, the method including: placing screen mesh on a support, the screen mesh having an outer edge and the support having an outer periphery, the outer edge of the screen mesh at the outer periphery of the support; and placing an edge panel on the screen mesh, a portion of the edge panel protecting the outer edge of the screen mesh. Such a method may have one or some, in any possible combination, of the following: securing the support with the screen mesh and edge panel thereon to a frame, the frame positioned beneath the support; the support has a peripheral ledge, the outer edge of the screen mesh is on the peripheral ledge, the method further including placing the edge panel so that an interior surface of the edge panel abuts the outer edge of the screen mesh to protect the outer edge of the screen mesh; the peripheral ledge having an outer side, the edge panel having a lip, the method further including locating the lip adjacent the outer side of the peripheral ledge; and/or the support having a peripheral ledge, the peripheral ledge having a lower inner surface and an upper outer surface, the outer edge of the screen mesh positionable on the lower inner surface, the method further including positioning the outer edge of the screen mesh on the lower inner surface.

The present invention, therefore, provides in at least some embodiments, a method for making a screen assembly, the method including: placing screen mesh within an opening of a screen support, the screen mesh having an outer edge; maintaining the screen mesh within the opening with a maintenance member beneath and supporting the screen mesh in place within the opening; placing an edge panel within the support, the edge panel having an inner part and an outer part, an inner part of the edge panel over the screen mesh's outer edge and the outer part of the edge panel on the screen support; securing the screen mesh to the support; and securing the edge panel to the support.

The present invention, therefore, provides in at least some embodiments, a screen assembly including: a frame, the frame having a ledge, the ledge having a top member with an underside, a support for supporting screen mesh, the support having an outer edge, screen mesh on the support, and the outer edge of the support located beneath and connected to the underside of the top member; and such a screen assembly may include an edge panel on the frame, a portion of the edge panel covering a portion of the screen mesh.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A screen assembly for use in screening material on a vibratory separator in which the material is fed to the screen assembly as the screen assembly is vibrated by vibratory apparatus of the vibratory separator, the screen assembly comprising
a support for supporting screen mesh,
the support having an outer periphery,
the screen mesh having an outer edge at the outer periphery of the support, and
an edge panel secured to the support, a portion of the edge panel covering the outer edge of the screen mesh.

2. The screen assembly of claim 1 further comprising
a frame, and
the support on and secured to the frame.

3. The screen assembly of claim 1
wherein the support has a peripheral ledge, the screen mesh's outer edge extending around the peripheral ledge of the support, and
the edge panel on the peripheral ledge and having an inner surface abutting the screen mesh's outer edge preventing contact with the screen mesh's outer edge.

4. The screen assembly of claim 3 wherein
the peripheral ledge has an outer side, and the edge panel has a lip projecting down adjacent the outer side of the peripheral ledge.

5. The screen assembly of claim 3 wherein
the peripheral ledge has a top with a first top surface and a second top surface, the first top surface located interiorly of the second top surface, the first top surface lower than the second top surface,
the outer edge of the screen mesh extending along the first top surface,
a space formed between the outer edge of the first top surface and the second top surface, and
filler material filling the space.

6. The screen assembly of claim 5 wherein
a portion of the filler material extends onto the second top surface.

7. The screen assembly of claim 5 wherein
the screen mesh has a top surface,
the filler material has a top surface, and
the top surface of the screen mesh is level with the top surface of the filler material.

8. The screen assembly of claim 3 wherein
the peripheral ledge of the support has a top member, the top member having an underside, and
the outer edge of the screen mesh positioned under the underside of the top member of the peripheral ledge.

9. The screen assembly of claim 8 wherein
the screen mesh has a bend so that a top surface of the screen mesh is level with a top surface of the top member.

10. The screen assembly of claim 1 wherein the screen mesh is a plurality of layers of screening material stacked together.

11. The screen assembly of claim 1 wherein
the support has a plurality os support sides,
each support side has a recess,
the screen mesh has a plurality of screen sides each screen side including a portion of the outer edge of the screen mesh, and
each portion of the outer edge of the screen mesh positioned in a recess of a support side.

12. The screen assembly of claim 11 wherein
a space is located between the outer edge of the screen mesh and inner surfaces of the recesses, and filler material fills the space.

13. The screen assembly of claim 1 wherein
the vibratory separator is a shale shaker, and
the material to be treated by the screen assembly is drilling fluid with drilled solids from a wellbore operation.

14. A screen assembly for use in screening material on a vibratory separator in which the material is fed to the screen assembly as the screen assembly is vibrated by vibratory apparatus of the vibratory separator, the screen assembly comprising
a support for supporting screen mesh, the support having a peripheral ledge,
the support having an outer periphery,
the screen mesh having a top surface, an outer edge at the outer periphery of the support,
the screen mesh's outer edge extending around the peripheral ledge of the support,
an edge panel secured to the support, a portion of the edge panel covering the outer edge of the screen mesh,
the edge panel on the peripheral ledge and having an inner surface abutting the screen mesh's outer edge preventing contact with the screen mesh's outer edge,
the peripheral ledge has a top with a first top surface and a second top surface, the first top surface located interiorly of the second top surface, the first top surface lower than the second top surface,
the outer edge of the screen mesh extending along the first top surface,
a space formed between the outer edge of the screen mesh and the second top surface,
filler material filling the space,
the filler material has a top surface, and
the top surface of the screen mesh is level with the top surface of the filler material.

15. A method for making a screen assembly, the screen assembly for use in screening material to be treated by a vibratory separator, the vibratory separator having vibrating apparatus for vibrating the screen assembly to assist in treating of the material, the method comprising
placing screen mesh on a support, the screen mesh having an outer edge and the support having an outer periphery, the outer edge of the screen mesh at the outer periphery of the support, and
placing an edge panel on the screen mesh, a portion of the edge panel protecting the outer edge of the screen mesh.

16. The method of claim 15 further comprising
securing the support with the screen mesh and edge panel thereon to a frame, the frame positioned beneath the support.

17. The method of claim 15 wherein
the support has a peripheral ledge,
the outer edge of the screen mesh is on the peripheral ledge, the method further comprising
placing the edge panel so that an interior surface of the edge panel abuts the outer edge of the screen mesh to protect the outer edge of the screen mesh.

18. The method of claim 17 wherein
the peripheral ledge has an outer side,
the edge panel has a lip,
the method further comprising
locating the lip adjacent the outer side of the peripheral ledge.

19. The method of claim 15 wherein
the support has a peripheral ledge,
the peripheral ledge has a lower inner surface and an upper outer surface,
the outer edge of the screen mesh is positionable on the lower inner surface, the method further comprising
positioning the outer edge of the screen mesh on the lower inner surface.

20. A method for making a screen assembly, the method comprising
placing screen mesh within an opening of a screen support, the screen mesh having an outer edge,
maintaining the screen mesh within the opening with a maintenance member beneath and supporting the screen mesh in place within the opening,
placing an edge panel within the support, the edge panel having an inner part and an outer part, an inner part of the edge panel over the screen mesh's outer edge and the outer part of the edge panel on the screen support,
securing the screen mesh to the support, and
securing the edge panel to the support.

21. A screen assembly for use in screening material on a vibratory separator in which the material is fed to the screen assembly as the screen assembly is vibrated by vibratory apparatus of the vibratory separator, the screen assembly comprising
a frame, the frame having a ledge, the ledge having a top member with an underside,
a support for supporting screen mesh,
the support having an outer edge,
screen mesh on the support, and
the outer edge of the support located beneath and connected to the underside of the top member.

22. The screen assembly of claim 21 further comprising
an edge panel on the frame, a portion of the edge panel covering a portion of the screen mesh.
